(19) United States
(12) Patent Application Publication
(10) Pub. No.: US 2012/0052360 A1
(43) Pub. Date: Mar. 1, 2012

(54) STACK TYPE BATTERY

(75) Inventors: Masayuki Fujiwara, Kasai-shi (JP); Yoshitaka Shinyashiki, Kobe-shi (JP); Hitoshi Maeda, Sumoto-shi (JP); Masao Kusukawa, Sumoto-shi (JP); Yuji Tani, Sumoto-shi (JP)

(73) Assignee: SANYO ELECTRIC CO., LTD., Osaka (JP)

(21) Appl. No.: 13/221,505

(22) Filed: Aug. 30, 2011

(30) Foreign Application Priority Data
Aug. 31, 2010 (JP) 2010-194147

(51) Int. Cl. H01M 10/02

(52) U.S. Cl. 429/127; 429/153

(57) ABSTRACT

Stacked positive and negative electrode current collector tabs are bundled respectively in such a manner as to be gathered at one stacking direction-wise side (the upper end side) of the stacked electrode assembly. Portions of the bundled tabs extending from the bundled portion toward a tip side of the bundled tabs are bent toward the other stacking direction-wise side (lower end side) of the stacked electrode assembly, to form bent portions. The stacked electrode assembly is covered and fixed by an insulating sheet having insulation capability so as to cover both stacking direction-wise end faces thereof and surround the stacked electrode assembly in a tubular shape. A portion (slip-in piece) of the insulating sheet is inserted between the stacked electrode assembly and the bent portions of the positive and negative electrode current collector tabs. A portion (outer cover piece) of the insulating sheet covers the bent portions of the positive and negative electrode current collector tabs from outside.

### BACKGROUND OF THE INVENTION

1. Field of the Invention

The present invention relates to stack type batteries, and more particularly to high capacity stack type batteries used as power sources for, for example, robots, electric vehicles, and backup power sources.

2. Description of Related Art

In recent years, batteries have been used for not only the power source of mobile information terminal devices such as mobile-phones, notebook computers, and PDAs but also for such applications as robots, electric vehicles, and backup power sources. This has led to a demand for higher capacity batteries. Because of their high energy density and high capacity, lithium-ion batteries are widely used as the power sources for such applications as described above.

The battery configurations of the lithium-ion batteries are broadly grouped into two types: one is a spirally-wound type lithium-ion battery, in which a spirally wound electrode assembly is enclosed in a battery case, and the other is a stack type lithium-ion battery (stack-type prismatic lithium ion battery), in which a stacked electrode assembly comprising a plurality of stacks of rectangular-shaped electrodes is enclosed in a battery can or a laminate battery case prepared by welding laminate films together.

Of the above-described lithium ion secondary batteries, the stack type lithium-ion battery has a stacked electrode assembly having the following structure. The stacked electrode assembly has a required number of sheet-shaped positive electrode plates each having a positive electrode current collector lead and a required number of sheet-shaped negative electrode plates each having a negative electrode current collector lead protruding therefrom. The positive electrode plates and the negative electrode plates are stacked with separators interposed between the positive and negative electrode plates.

As disclosed in Japanese Published Unexamined Patent Application No. 8-64199, for example, in a lithium-ion battery, the electrode assembly is covered with an electrode assembly cover having an upper face opening and made of an insulating material so that the electrode assembly can be easily inserted in the battery can which is a battery case or that electrode tabs can be insulated reliably in the battery can. Japanese Published Unexamined Patent Application No. 8-64199 also discloses that a guide piece for guiding a loosened part of the electrode tab along a lid-side end face of the electrode assembly is formed at the upper face of the opening of the electrode assembly cover so that the loosened part of the electrode tab can be disposed along the lid-side end face of the electrode assembly in assembling the battery and can be reliably insulated without causing short circuiting in the battery can.

Japanese Published Unexamined Patent Application No. 2009-245819 discloses that a spacer is disposed in a space between a stacked electrode assembly and the inner side surface of a laminate battery case so that positioning of the current collector tabs and the current collector terminals can be effected.

In a stack type battery, a plurality of positive and negative electrode current collector tabs protruding from the respective electrode plates are joined respectively to positive and negative electrode current collector terminals by ultrasonic welding so as to be stacked and overlapped with one another. In the case of a high-capacity stack type battery that needs to be charged and discharged at high rate, the number of the stacks tends to be larger in order to achieve a high capacity, and the thickness of the current collector terminals tends to be greater in order to pass a large current therethrough. This necessitates ultrasonic welding of a large number of electrode plate tabs each made of metal foil to the current collector terminal made of a thick metal plate. However, in this case, weldability of the welded portions between the metal foils and the metal plate tends to be poorer than that of the welded portions of the metal foils to each other, because of their thickness difference. When the weldability becomes poor, the connection resistance between each of the electrode plates and the current collector terminal becomes non-uniform, causing variations in the current values flowing into the respective electrode plates especially when used at high rate. As a consequence, uneven charge-discharge states arise in the battery, causing overdischarge and overcharge partially. Consequently, the cycle performance of the battery deteriorates.

In view of the problem, Japanese Published Unexamined Patent Application No. 2009-87611 discloses that, in addition to joining the positive and negative electrode current collector tabs to the positive and negative electrode current collector terminals, the stacked current collector tabs are joined to one another by ultrasonic welding or the like at a location between the current collector terminals and the electrode plates, in other words, at a location where only the current collector tabs exist, to thereby uniformize the connection resistance between the electrode plates and the current collector terminals and to inhibit variations of the current values flowing into the electrode plates. (In the present specification, this type of connection structure is also referred to as a “two-stage connection structure”).

In the stack type battery, especially in the high capacity stack type battery that requires high-rate charge and discharge, the stacked electrode assembly needs to be accommodated in the battery case in an as efficient manner as possible, in order to obtain a high energy density. However, when the above-described two-stage connection structure is employed, the joining portion for only the current collector tabs needs to be provided between the current collector terminals and the electrode plates, and correspondingly, the length of the current collector tabs inevitably becomes long. Accordingly, the space occupied by the current collector tabs in the battery becomes large, and consequently, the volumetric energy density of the battery decreases. To deal with the just-described problem in the two-stage connection structure, the stacked positive and negative electrode current collector tabs are bundled in such a manner as to be gathered at one stacking direction-wise side of the stacked electrode assembly, and the portions extending from the bundled portion to the tip side are bent toward the other stacking direction-wise side of the stacked electrode assembly. Thereby, the current collector tabs as a whole are folded at an intermediate location of the protruding portion and shortened along the protruding direction, to prevent the current collector tabs from occupying a large space. Even in the case where the two-stage connection structure is not employed, the space occupied by the current collector tabs can be reduced by employing the folding structure of the current collector tabs as described above. In other words, the folding structure of the current collector tabs is effective for reducing the space occupied by the current collector tabs in either case. However, the folding structure is more effective in the case of employing the two-stage connection structure, in which the lengthwise space occupied by the current collector tabs is inevitably greater.

When the folding structure of the current collector tabs is employed, the current collector tabs tend to be instable and wobble at the bent portion. In addition, since the folded current collector tabs are under a force such as to return to the original shape, the current collector portion easily moves and does not easily remain at a predetermined position. This results in various problems such as misalignment of the current collector tabs, poor sealing performance, and breakage of the terminal parts. Conventionally, the current collector portion is fixed with a tape. However, this makes accurate positioning difficult, and the work is troublesome.

In addition, when manufacturing the stacked electrode assembly of the stack type battery, the positive electrode plates, the separators, and the negative electrode plates are alternately stacked on one another, and lastly the entire assembly is fixed by a tape. However, this fixing work is troublesome in addition to the fixing of the current collector portion. Moreover, although the stacking work may be carried out by a machine while performing accurate positioning, misalignment can occur easily during the fixing work with a tape, so it is difficult to ensure accuracy.

Neither Japanese Published Unexamined Patent Application Nos. 8-64199 nor 2009-245819 disclose the folding structure of the current collector tabs. Accordingly, neither of them describes any means to solve the problem of the positioning of the current collector portion in the folding structure.

### BRIEF SUMMARY OF THE INVENTION

In view of the foregoing and other problems, it is an object of the present invention to provide a stack type battery that enables easy and reliable positioning of the current collector portion and easy and accurate manufacturing of the stacked electrode assembly.

In order to accomplish the foregoing and other objects, the present invention provides a stack type battery, comprising:

a stacked electrode assembly comprising a plurality of positive electrode plates having respective positive electrode current collector tabs protruding therefrom, a plurality of negative electrode plates having respective negative electrode current collector tabs protruding therefrom, and separators interposed between the positive electrode plates and the negative electrode plates, the positive electrode plates and the negative electrode plates being alternately stacked one another with the separators; wherein:

the stacked positive and negative electrode current collector tabs are bundled in such a manner as to be gathered at one stacking direction-wise side of the stacked electrode assembly, and portions of the bundled tabs extending from a bundled portion to a tip side of the bundled tabs are bent toward the other stacking direction-wise side of the stacked electrode assembly, to form bent portions;

the stacked electrode assembly is covered and fixed by an insulating sheet having insulation capability so as to cover both stacking direction-wise end faces thereof and surround the stacked electrode assembly in a tubular shape; and

a portion of the insulating sheet is inserted between the stacked electrode assembly and the bent portions of the positive and negative electrode current collector tabs, and a portion of the insulating sheet covers the bent portions of the positive and negative electrode current collector tabs from outside.

With the stack type battery according to the present invention, the current collector portion can be positioned easily and reliably, and also, the stacked electrode assembly can be manufactured easily and accurately.

### BRIEF DESCRIPTION OF THE DRAWINGS

FIG. 1 shows portions of a stack type battery according to the present invention, wherein FIG. 1(a) is a plan view illustrating a positive electrode thereof, FIG. 1(b) is a perspective view illustrating a separator thereof, and FIG. 1(c) is a plan view illustrating a pouch-type separator thereof in which the positive electrode is disposed;

FIG. 2 is a plan view illustrating a negative electrode plate used for the stack type battery of the present invention;

FIG. 3 is a developed view of an insulating sheet used for the stack type battery according to the present invention;

FIG. 4 is a cross-sectional view taken along line A-A in FIG. 3;

FIG. 5 is a perspective view illustrating how pouch-type separators and negative electrode plates are stacked;

FIG. 6 is a side view illustrating how the stacked positive and negative electrode current collector tabs are shaped;

FIG. 7 is a perspective view illustrating how an insulating sheet is folded and shaped;

FIG. 8 is a side view illustrating a stacked electrode assembly in which a current collector portion is shaped;

FIG. 9 is a perspective view illustrating how the positive and negative electrode current collector terminals are connected to the positive and negative electrode current collector tabs (without the insulating sheet);

FIG. 10 is a perspective view illustrating how the positive and negative electrode current collector terminals are connected to the positive and negative electrode current collector tabs (with the insulating sheet);

FIG. 11 is a perspective view illustrating a stacked electrode assembly that is completed;

FIG. 12 is a perspective view illustrating how a stacked electrode assembly is inserted in a battery case used for the stack type battery according to the present invention; and

FIG. 13 is a developed view illustrating an insulating sheet used for a stack type battery according to another embodiment.

### DETAILED DESCRIPTION OF THE INVENTION

In order to accomplish the foregoing and other objects, the present invention provides a stack type battery, comprising: a stacked electrode assembly comprising a plurality of positive electrode plates having respective positive electrode current collector tabs protruding therefrom, a plurality of negative electrode plates having respective negative electrode current collector tabs protruding therefrom, and separators interposed between the positive electrode plates and the negative electrode plates, the positive electrode plates and the negative electrode plates being alternately stacked one another with the separators wherein: the stacked positive and negative electrode current collector tabs are bundled in such a manner as to be gathered at one stacking direction-wise side of the stacked electrode assembly, and portions of the bundled tabs extending from a bundled portion to a tip side of the bundled tabs are bent toward the other stacking direction-wise side of the stacked electrode assembly, to form bent portions; the stacked electrode assembly is covered and fixed by an insulating sheet having insulation capability so as to cover both stacking direction-wise end faces thereof and surround the stacked electrode assembly in a tubular shape; and a portion of the insulating sheet is inserted between the stacked electrode assembly and the bent portions of the positive and negative electrode current collector tabs, and a portion of the insulating sheet covers the bent portions of the positive and negative electrode current collector tabs from outside.

In the present invention, the phrase “the stacked electrode assembly is covered and fixed by an insulating sheet having insulation capability so as to cover both stacking direction-wise end faces thereof and surround the stacked electrode assembly in a tubular shape” means that, for example, when the stacked electrode assembly is a hexahedron, four faces of the stacked electrode assembly that consist of both stacking direction-wise end faces and two faces of the remaining four faces that are opposed to each other, are surrounded in a tubular shape and covered and fixed by the insulating sheet. The remaining two faces may be left open, or at least one face of the remaining two faces may be closed.

The term “current collector portion” herein generally refers to a current-collector-side portion of the stack type battery, including the metallic parts therein such as the positive and negative electrode current collector tabs and the positive and negative electrode current collector terminals, but it may also refer to the metallic parts alone.

With the above-described configuration of the present invention, the bent portions of the positive and negative electrode current collector tabs are retained in such a posture as to be sandwiched from inside and outside by a portion of the insulating sheet. Thereby, the current collector portion is retained and positioned at a predetermined position accurately and reliably, and the posture of the current collector portion is also retained, i.e., shaped, in a predetermined posture accurately and reliably. In addition, the positioning and shaping of the current collector portion are effected using a portion of the insulating sheet that covers the stacked electrode assembly so as to cover both stacking direction-wise end faces thereof and surround the stacked electrode assembly in a tubular shape. Therefore, the current collector portion is supported stably and firmly, and the positioning and shaping of the current collector portion can be carried out integrally with, i.e., at the same time as, the covering of the entire stacked electrode assembly by the insulating sheet. As a result, the work can be done more easily and simply, and moreover accurately, in comparison with, for example, the case where the current collector portion is fixed locally by a tape.

Moreover, the stacked electrode assembly is covered and fixed by the insulating sheet so as to cover both stacking direction-wise end faces thereof and surround the stacked electrode assembly in a tubular shape. Therefore, the entire stacked electrode assembly can be fixed at one time unlike the case where a plurality of locations of the stacked electrode assembly are fixed by a tape. This makes the work easier and simpler, and the misalignment such as that occurs in the case of using a tape for fixing the parts does not occur easily. Therefore, the accuracy of the positioning can be ensured easily. Furthermore, unlike the case of using a tape for fixing the parts, it is possible to carry out the entire manufacturing process of the stacked electrode assembly by a machine.

In addition, since the stacked electrode assembly is covered by the insulating sheet so as to cover both stacking direction-wise end faces thereof and surround the stacked electrode assembly in a tubular shape, the stacked electrode assembly is provided with good insulation. In particular, the current collector portion is provided with good insulation since the current collector portion is retained in such a posture as to be sandwiched from inside and outside by a portion of the insulating sheet.

It is desirable that the portion of the insulating sheet inserted between the stacked electrode assembly and the bent portions of the positive and negative electrode current collector tabs has a greater thickness than the remaining portion of the insulating sheet.

In the just-described configuration, the bent portions of the positive and negative electrode current collector tabs are supported from inside by the thick insulating sheet. As a result, the positioning and shaping of the current collector portion can be done more easily and reliably.

It is desirable that the portion of the insulating sheet covering the bent portions of the positive and negative electrode current collector tabs from outside protrude more than protruding ends of the bent portions of the positive and negative electrode current collector tabs.

With the just-described configuration, the metallic parts of the current collector portion can be covered with the insulating sheet more reliably.

It is desirable that the portion of the insulating sheet protrude 0.5 mm to 1.0 mm more than the protruding ends of the bent portions of the positive and negative electrode current collector tabs. When the difference between the protruding length of the portion of the insulating sheet and the protruding length of the bent portions of the positive and negative electrode current collector tabs is 0.5 mm or greater, the metallic parts of the current collector portion can be covered by the insulating sheet more reliably. Moreover, when the difference is 1 mm or less, it is easy to avoid the problem that, for example, the protruding end portion of the portion of the insulating sheet is tucked into the seal portion of the laminate battery case because the protruding length is too large.

It is desirable that a flap be formed at least a portion of a seam portion of the insulating sheet and at least a portion of the seam portion be joined by overlaying and joining the flap.

With the just-described configuration, at least a portion of the seam portion of the insulating sheet can be joined easily and reliably.

It is desirable that the stacked electrode assembly be accommodated in a battery case having flexibility.

Examples of the usable battery case include a battery can and a laminate battery case made by welding laminate films. However, in the case of the battery can, the battery can itself has certain shape-retaining capability (rigidity). Therefore, the positioning and shaping of the current collector portion are effected by configuring the current collector portion by fixing the positive and negative electrode current collector tabs to the battery can, and even when the battery receives external force, the position and posture of the current collector portion do not easily shift. In contrast, in the case of a battery case having flexibility such as the laminate battery case, the battery case itself does not have shape-retaining capability (rigidity). Therefore, it is necessary to conduct the positioning and shaping of the current collector portion by other parts than the battery case, and moreover, when the battery receives external force, for example, the position and posture of the current collector portion tend to shift easily. For these reasons, the configuration of the present invention, in which the positioning and shaping of the current collector portion are done by a portion of the insulating sheet, is especially effective in the case of the battery case having flexibility. In particular, the positioning of the electrode terminals and the current collection structure is especially important when thermally welding the laminate battery case with the electrode assembly being disposed in the laminate battery case and the current collector terminals sandwiched between the laminate films (in other words, when thermally welding and scaling the laminate battery case). In this respect, the configuration of the present invention, in which the positioning and shaping of the current collector portion are done by a portion of the insulating sheet, is particularly effective.

In addition, the laminate film has a structure in which both sides of a metal foil (aluminum foil) are coated with a resin, and therefore serves as an insulator. For this reason, when using the laminate battery (use, the insulation between the stacked electrode assembly and the laminate battery case is generally unnecessary. Nevertheless, there may be cases in which the laminate battery case does not serve as a perfect insulator because the resin coating may peel off at, for example, a corner portion. Thus, the configuration of the present invention battery, in which the stacked electrode assembly is covered substantially entirely with the insulating sheet having insulation capability, is particularly effective from the viewpoint of ensuring insulation.

It is desirable that the stack type battery further comprise a spacer for filling at least a portion of a gap formed in a current collector portion.

When employing the configuration in which the stacked electrode assembly is accommodated in a battery case having flexibility, the battery case is sealed while evacuating the inside of the battery case (i.e., vacuum-sealing is performed) in order to infiltrate the electrolyte solution sufficiently into the inside of the electrode assembly. During this process, a gap tends to form easily between the electrode assembly and the battery case, particularly in the current collector portion, and at the location where the gap is formed, creases and warpage tend to form in the battery case because of the internal pressure change associated with the evacuation. When the gap formed in the current collector portion is filled by the spacer as described above, the creases and warpage in the battery case resulting from the evacuation can be prevented.

It is desirable that the insulating sheet have a liquid passage port.

The just-described configuration allows the electrolyte solution to enter the inside of the insulating sheet more easily.

It is desirable that the stacked electrode assembly is fixed with pressure by thermally shrinking the insulating sheet after covering and fixing the stacked electrode assembly by the insulating sheet.

In the just-described configuration, after covering and fixing the stacked electrode assembly by the insulating sheet, the insulating sheet is heated to cause thermal shrinkage. Thereby, the stacked electrode assembly can be fixed with pressure, so the stacked electrode assembly can be fixed more firmly and stably.

Hereinbelow, with reference to the drawings, the present invention is described in further detail based on certain embodiments and examples thereof. It should be construed, however, that the present invention is not limited to the following embodiments and examples, and various changes and modifications are possible without departing from the scope of the invention.

### Preparation of Positive Electrode

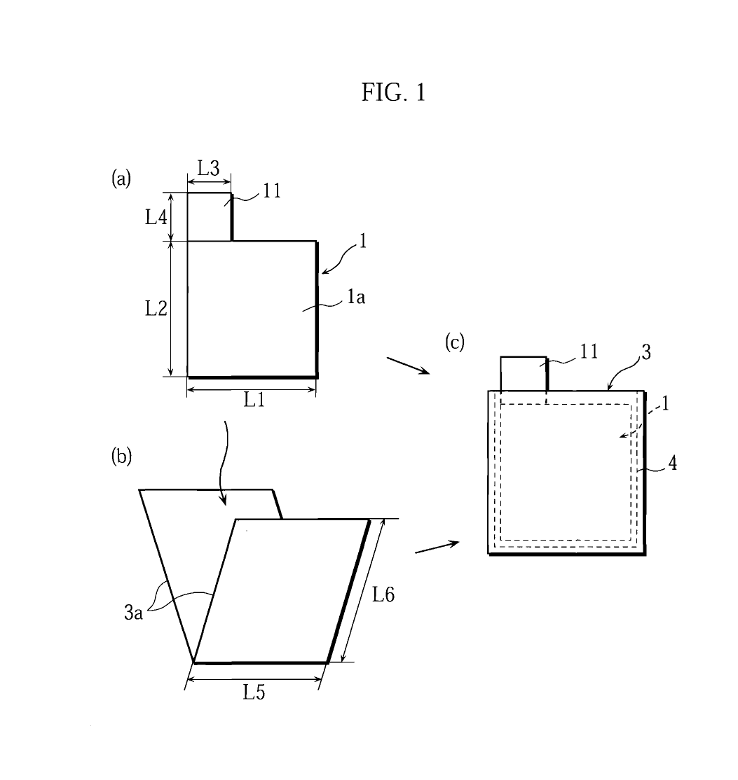

90 mass % of LiCoO₂ as a positive electrode active material, 5 mass % of carbon black as a conductive agent, and 5 mass % of polyvinylidene fluoride as a binder agent were mixed with a N-methyl-2-pyrrolidone (NMP) solution as a solvent to prepare a positive electrode mixture slurry. Thereafter, the resultant positive electrode mixture slurry was applied onto both sides of an aluminum foil (thickness: 15 μm) serving as a positive electrode current collector. Thereafter, the material was heated to remove the solvent and compressed with rollers to a thickness of 0.1 mm. Subsequently, as illustrated in FIG. 1(a), it was cut into pieces each having a width L1 of 85 mm and a height L2 of 85 mm, to prepare positive electrode plates 1 each having a positive electrode active material layer 1a on each side. At this point, in each of the positive is electrode plates 1, an active material-uncoated portion having a width L3=30 mm and a height L4=20 mm was allowed to protrude outwardly from one end (the left end in FIG. 1(a)) of one side of the positive electrode plate 1 that extends along the width L1, to form a positive electrode current collector tab 11.

### Preparation of Negative Electrode

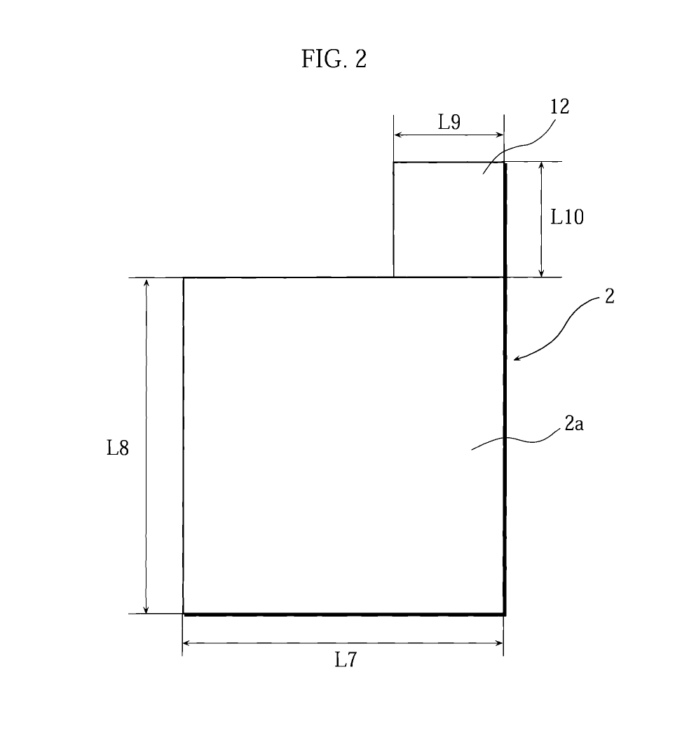

95 mass % of graphite powder as a negative electrode active material and 5 mass % of polyvinylidene fluoride as a binder agent were mixed with an NMP solution as a solvent to prepare a negative electrode slurry. Thereafter, the resultant negative electrode slurry was applied onto both sides of a copper foil (thickness: 10 μm) serving as a negative electrode current collector. Thereafter, the material was heated to remove the solvent and compressed with rollers to a thickness of 0.08 mm. Subsequently, as illustrated in FIG. 2, it was cut into pieces each having a width L7 of 90 mm and a height L8 of 90 mm, to prepare negative electrode plates 2 each having a negative electrode active material layer 2a on each side. At this point, in each of the negative electrode plates 2, an active material-uncoated portion having a width L9 of 30 mm and a height L10 of 20 mm was allowed to protrude outwardly from one end (the right end in FIG. 2) of the negative electrode plate 2 that is opposite to the side end thereof at which the positive electrode tab 11 was formed, in one side of the negative electrode plate 2 that extends along the widthwise direction, to form a negative electrode tab 12.

Preparation of Pouch-Type Separator in which the Positive Electrode Plate is Disposed

The positive electrode plate 1 was disposed between two square-shaped polypropylene (PP) separators 3a (thickness: 30 μm) as illustrated in FIG. 1(b), each having a width L5 of 90 mm and a height L6 of 94 mm. Thereafter, as illustrated in FIG. 1(c), the three sides of the separators 3a, other than the side from which the positive electrode current collector tab 11 protrudes, were thermally sealed at a sealing part 4, to prepare a pouch-type separator 3, in which the positive electrode plate 1 was accommodated.

### Preparation of Insulating Sheet

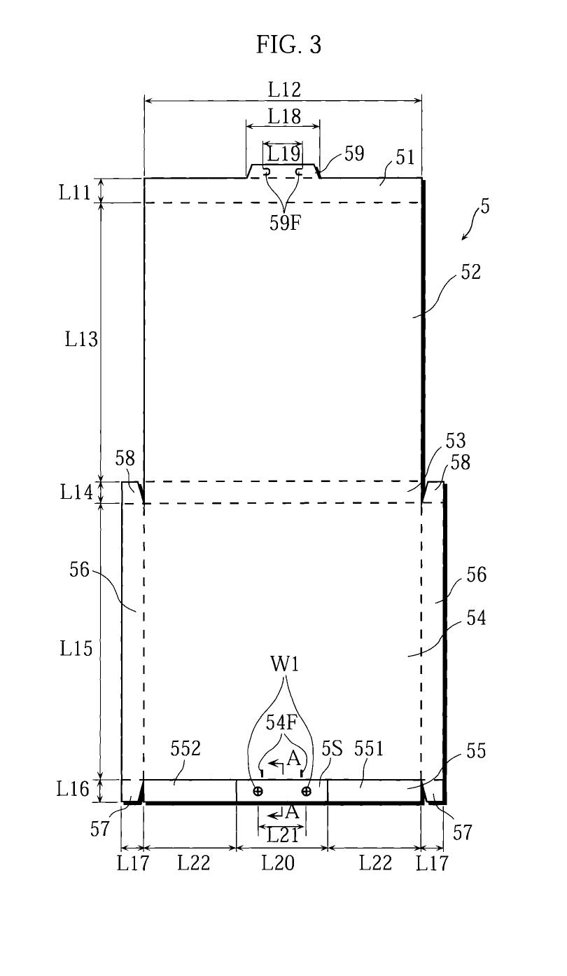

An insulating sheet 5 as illustrated in FIG. 3 was prepared using a polypropylene (PP) sheet having a thickness of 0.2 mm. As illustrated in the figure, the insulating sheet 5 has an outer cover piece 51 having a length L11=11 mm and a width L12=90 mm, an upper wall portion 52 having a length L13=94 mm and a width L12=90 mm, back-wall portion 53 having a length L14=11 mm and a width L12=90 mm, a lower wall portion 54 having a length L15=L13=94 mm and a width L12=90 mm, and a slip-in piece 55 having a length L16=10.5 mm and a width L12=90 mm, which are formed continuously in that order. Side wall pieces 56 each having a horizontal width L17=L14=11 mm protrude from the respective side edges of the lower wall portion 54. Front-side flaps 57 protrude from the respective front side edges (the lower edges in FIG. 3) of the side wall pieces 56. Each of the front-side flaps 57 has a length L16=10.5 mm and a width L17=L14=11 mm and has a side edge facing the slip-in piece 55 that is formed obliquely so as to be easily assembled. Back-side flaps 58 protrude from the respective back-side edges (the upper edges in FIG. 3) of the side wall pieces 56. Each of the back-side flaps 58 has a length L14=11 mm and a width L17=L14=11 mm, and has a side edge facing the back-wall portion 53 that is formed obliquely so as to be easily assembled. A securing piece 59 having a horizontal width L18=30 mm and protruding outwardly and slightly tapering in a trapezoidal shape is formed at a central portion of the outer side edge (the upper edge in FIG. 3) of the outer cover piece 51. Two grommet portions 59F, each configured by forming a U-shaped incision so that the small piece can be pulled up, are provided at two respective locations, on the right and on the left, in the securing piece 59, at an edge-to-edge distance L19=12 mm. Slits 54F are provided, corresponding to the grommet portions 59F, in a central portion of the lower wall portion 54 that is near the outer side edge (the lower edge in FIG. 3).

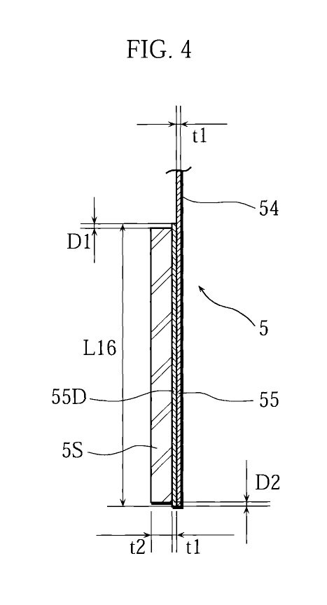

As illustrated in FIGS. 3 and 4, a rectangular (strip-shaped) additional piece 55D made of PP and having the same dimensions (length L16=10.5 mm, width L12=90 mm, thickness t1=0.2 mm) as those of the slip-in piece 55 is affixed to a surface of the slip-in piece 55 by an adhesive agent, whereby the thickness of the slip-in piece 55 is doubled. In addition in a central portion on the surface of the additional piece 55D, a rectangular plate-shaped spacer 5S is provided at a location with gaps D1=0.7 mm and D2=0.2 mm respectively from the upper end and the lower end of the additional piece 55D. The spacer 5S has a length of 9.6 mm (=L16−D1−D2), a width L20 of 30 mm, and a thickness t2 of 1.2 mm, and it is made of polytetrafluoroethylene. The spacer 5S is fixed to the additional piece 55D by ultrasonic welding at two left and right weld points W1 with a center-to-center distance L21 of 12 mm. Thus, the spacer 5S fills the gap formed between the slip-in piece 55 and a later-described stacked electrode assembly 10, and in an intermediate portion between a positive electrode current collector tab-inserting portion 551 and a negative electrode current collector tab-inserting portion 552, which are provided at both sides and have a width L22=30 mm.

It should be noted that the names of the parts of the insulating sheet 5, such as the upper wall portion 52, the back-wall portion 53, the lower wall portion 54, and the side wall pieces 56, are named provisionally mainly based on the posture (arrangement) of the insulating sheet 5 during, for example, the later-described manufacturing process of the stacked electrode assembly 10 and the later-described tilling process of the electrolyte solution, and that they do not necessarily correspond to the positions of the parts in actual use of the battery.

### Preparation of Stacked Electrode Assembly

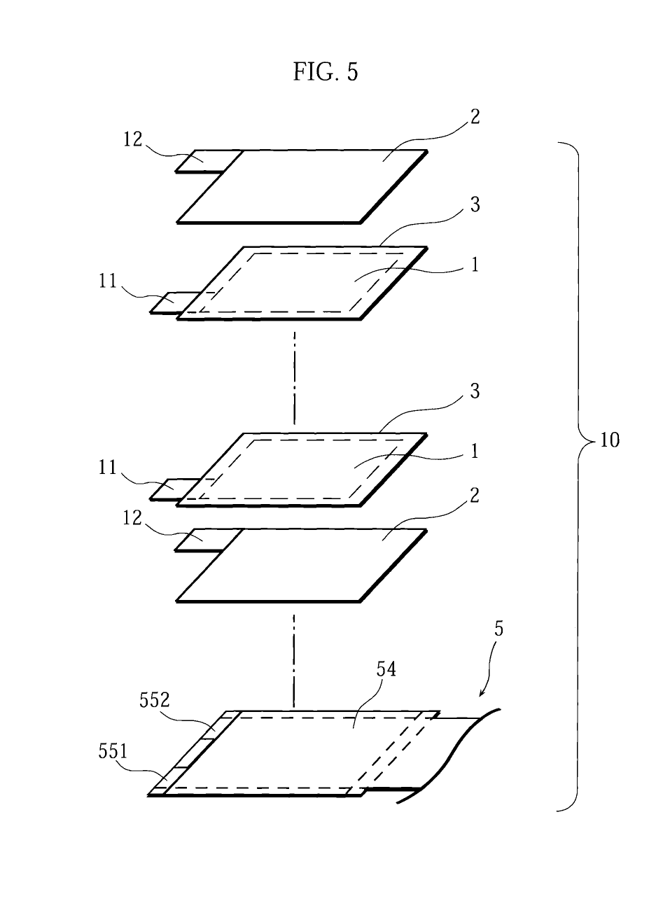

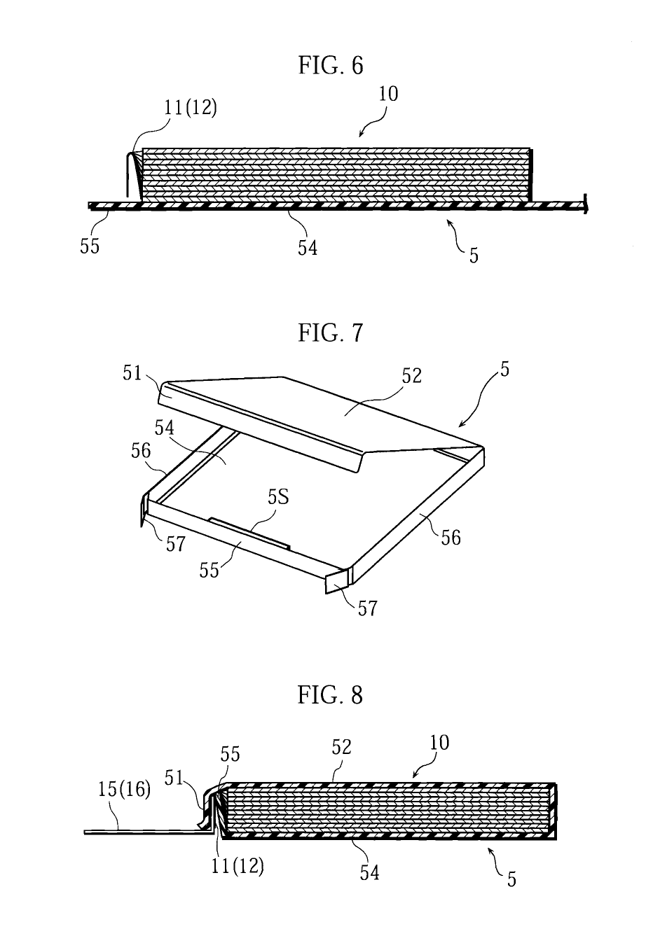

35 sheets of the pouch-type separators 3 in each of which the positive electrode plate 1 was disposed and 36 sheets of the negative electrode plates 2 were prepared. Then, as illustrated in FIG. 5, the pouch-type separators 3 and the negative electrode plates 2 were alternately stacked one on the other on top of the lower wall portion 54 of the insulating sheet 5 in a developed state so that the positive electrode current collector tabs 11 and the negative electrode current collector tabs 12 protrude outwardly from the positive electrode current collector tab-inserting portion 551 and the negative electrode current collector tab-inserting portion 552 respectively. In this process, the stacked electrode assembly 10 was configured so that negative electrode plates 2 were placed on both top and bottom end faces of the stacked electrode assembly 10. Next, as illustrated in FIG. 6, the stacked positive and negative electrode current collector tabs 11, 12 were bundled respectively in such a manner as to be gathered at one stacking direction-wise side (i.e., the upper end side in FIG. 6, the stacking direction being a vertical direction) of the stacked electrode assembly 10. Subsequently, the tip portions of the stacked positive and negative electrode current collector tabs 11, 12 were cut to shape the respective-tip portions of the stacked positive and negative electrode current collector tabs 11, 12. Thereafter, the positive electrode current collector tabs 11 and the negative electrode current collector tabs 12 were joined to a positive electrode current collector terminal 15 and a negative electrode current collector terminal 16, respectively, by welding. Then, the slip-in piece 55 of the insulating sheet 5 was folded upward along the stacked electrode assembly 10, and respective portions of the positive electrode current collector tabs 11 and the negative electrode current collector tabs 12 that extend from the bundled portion to the tip side were shaped so as to be bent toward the other stacking direction-wise side (the lower end side in FIG. 6) of the stacked electrode assembly 10. Thereafter, as illustrated in FIG. 7, the fold lines (dashed lines in FIG. 3) in the insulating sheet 5 corresponding to the boundaries between the respective parts were folded inwardly so as to cover (i.e., wrap) the entirety of the six faces of the stacked pouch-type separators 3 and the negative electrode plates 2 (not shown in FIG. 7) by the insulating sheet 5, whereby the stacked electrode assembly 10 was fixed.

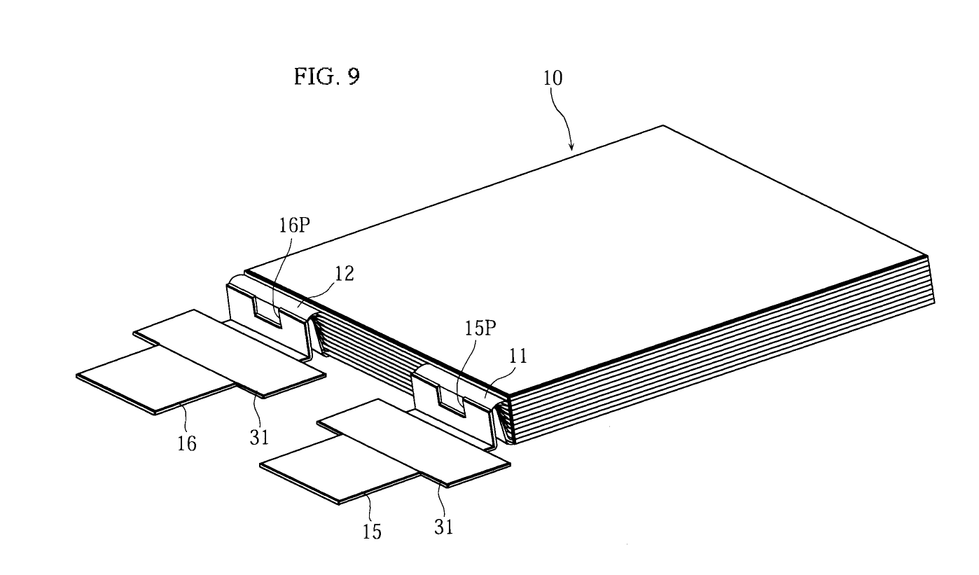

Thereby, as illustrated in FIG. 8, the slip-in piece 55 of the insulating sheet 5 was inserted between the stacked electrode assembly 10 and the bent portions of the positive electrode current collector tabs 11 and the negative electrode current collector tabs 12, and the outer cover piece 51 of the insulating sheet 5 covered the bent portions of the positive electrode current collector tabs 11 and the negative electrode current collector tabs 12 from outside.

### Welding of Current Collectors

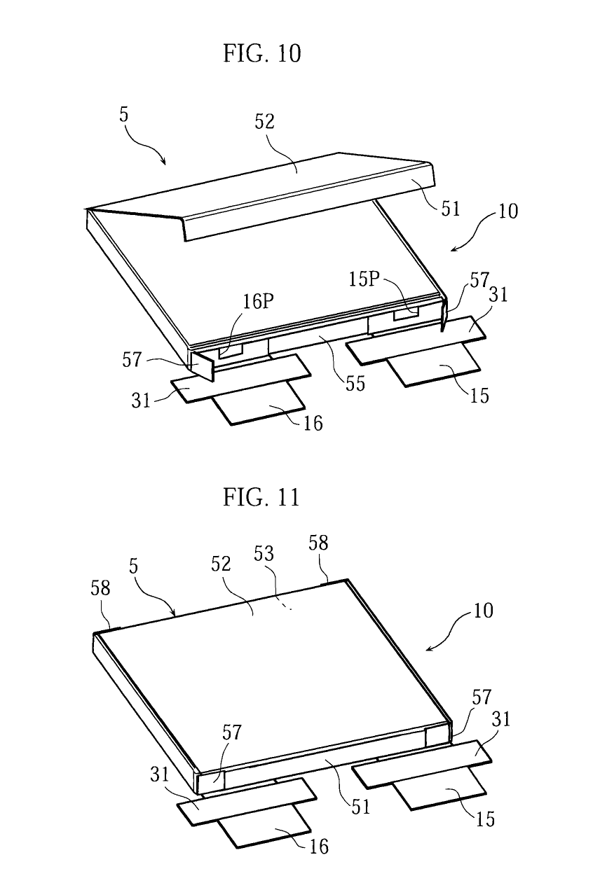

The details of the method for connecting the positive and negative electrode current collector tabs 11, 12 with the positive and negative electrode current collector terminals 15, 16 will be described. As illustrated in FIGS. 9 and 10, the positive electrode current collector terminal 15 made of an aluminum plate having a width of 30 mm and a thickness of 0.4 mm and the negative electrode current collector terminal 16 made of a copper plate having a width of 30 mm and a thickness of 0.4 mm were joined to the respective protruding end portions of the positive electrode current collector tabs 11 and the negative electrode current collector tabs 12, respectively, by ultrasonic welding.

In this process, as illustrated in the figures, a central portion of one peripheral edge of the positive electrode current collector terminal 15 was cut away inwardly in a rectangular shape, to form a penetrating portion 15P having a width of 10 mm and a depth of 5 mm. Then, while the peripheral edge portion of the positive electrode current collector terminal 15 in which the penetrating portion 15P was formed was kept to overlapped with the positive electrode current collector tabs 11, the 35 sheets of the positive electrode current collector tabs 11 only were first joined to each other by ultrasonic welding at a weld point (hereinafter referred to as the “center weld point”) located in the penetrating portion 15P. Next, the 35 sheets of the positive electrode current collector tabs 11 were joined to the positive electrode current collector terminal 15 by ultrasonic welding at weld points (hereinafter referred to as a “side weld points”) adjacent to the center weld point and located on both sides of the center weld point along the widthwise direction.

On the other hand, a penetrating portion 16P was formed likewise in the negative electrode current collector terminal 16 in the same manner as in the case of the positive electrode current collector terminal 15. Then, only the 36 sheets of the negative electrode current collector tabs 12 were joined to each other by ultrasonic welding at a center weld point, and next, the 36 sheets of the negative electrode current collector tabs 12 were jointed to the negative electrode current collector terminal 16 at both side weld points by ultrasonic welding.

In the above-described joining structure, only the 35 sheets and 36 sheets, respectively, of the positive and negative electrode lead tabs 11, 12 are joined to each other respectively at the center weld points. Thereby, a closed circuit is formed, so that the connection resistance is made uniform. Therefore, variations are not caused in the current value flowing into each one of the positive and negative electrode plates 1 and 2 even during high-rate charge and discharge, and good cycle performance can be obtained.

Moreover, the center weld point and both side weld points are disposed so as to be lined up perpendicularly to the connection direction of the positive and negative electrode current collector tabs 11 and 12, that is, along the widthwise direction. Therefore, the occupied area by the joining portions, including the center weld point and both side weld points, is not increased along the connection direction of the positive and negative electrode current collector tabs 11 and 12, and is kept minimum. As a result, the battery size is not increased, and the volumetric energy density is maintained at a desired level. In other words, with the just-described joining structure, the stacked positive or negative electrode current collector tabs 11, 12 are joined to each other by, for example, ultrasonic welding at a location where only the positive or negative electrode current collector tabs 11 and 12 exist, as in the case with the previously-described two-stage connection structure. Thereby, the connection resistance between the positive and negative electrode plates 1, 2 and the positive and negative electrode current collector terminals 15, 16 can be uniformized, and the current value flowing into each of the electrode plates 1, 2 can be inhibited from causing variations. Moreover, the occupied area by the joining portions is prevented from increasing in comparison with the case of the previously-described two-stage connection structure.

As illustrated in FIG. 9, the positive and negative electrode current collector terminals 15 and 16 were folded upward so that the side ends thereof where the penetrating portions 15P and 16P were formed were in a hook-like shape as viewed from side, and to the folded portions, the bent portions of the positive and negative electrode current collector tabs 11, 12 were overlapped and welded. Note that reference numeral 31 shown in FIG. 9 and other drawings denotes a resin sealing material (adhesive material), formed so as to be firmly bonded to each of the positive and negative electrode current collector terminals 15 and 16 in a strip shape along the widthwise direction, for ensuring hermeticity when heat-sealing a later-described battery case 18.

### Shaping and Fixing of Current Collector Portion

As illustrated in FIG. 8, the outer cover piece 51 of the insulating sheet 5 was folded downward so as to cover the bent portions of the positive and negative electrode to current collector tabs 11 and 12, to which the positive and negative electrode current collector terminals 15 and 16 were joined, from outside. Here, the outer cover piece 51 is configured so as to protrude about 1 mm more than the protruding ends of the bent portions of the positive and negative electrode current collector tabs 11 and 12. As illustrated in the figure, the protruding ends of the bent portions of the positive and negative electrode current collector tabs 11 and 12 are located at the folded positions of the positive and negative electrode current collector terminals 15 and 16. Accordingly, the distal end of the outer cover piece 51 protrudes about 1 min from the folded positions of the positive and negative electrode current collector terminals 15 and 16 so that it sits slightly over the main parts (horizontal parts in FIG. 8) of the positive and negative electrode current collector terminals 15 and 16 that are bent in a hook-like shape and are extended from the folded pieces (vertical parts in FIG. 8) of the positive and negative electrode current collector terminals 15 and 16. Thus, the bent portions of the positive and negative electrode current collector tabs 11, 12 and the folded pieces of the positive and negative electrode current collector terminals 15, 16 are prevented from being exposed and are covered by the outer cover piece 51 reliably. In addition, the slip-in piece 55 of the insulating sheet 5 is inserted the stacked electrode assembly 10 and the bent portions of the positive and negative electrode current collector tabs 11 and 12 from below, as described above. Thus, the current collector portion is shaped in such a manner that the bent portions of the positive and negative electrode current collector tabs 11 and 12 are supported by the slip-in piece 55 of the insulating sheet 5 and the outer cover piece 51 from both inside and outside. Under this condition, the grommet portions 59F of the securing piece 59, formed at the distal end of the outer cover piece 51 of the insulating sheet 5, were inserted into the slits 54F of the lower wall portion 54 to fix the securing piece 59. Furthermore, as illustrated in FIG. 11, the front-side flaps 57 of the insulating sheet 5 were overlapped with the outer cover piece 51 from outside and then joined thereto by thermal welding, and the back-side flaps 58 were likewise joined to the back-wall portion 53, to complete the stacked electrode assembly 10 that was covered and fixed by the insulating sheet 5. Additionally, it is possible to heat the entirety of the insulating sheet 5 to allow the insulating sheet 5 to undergo thermal shrinkage so that the stacked electrode assembly 10 can be fixed with it being under pressure.

### Placing the Electrode Assembly in Battery Case

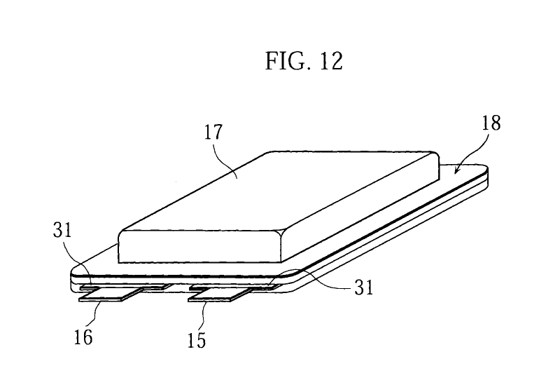

As illustrated in FIG. 12, the above-described stacked electrode assembly 10 was inserted into a battery case 18 formed of laminate films 17, which had been formed in advance so that the stacked electrode assembly 10 could be placed therein. Then, three sides of the battery case, including the side containing the positive electrode current collector terminal 15 and the negative electrode current collector terminal 16, were thermally bonded so that only the positive electrode current collector terminal 15 and the negative electrode current collector terminal 16 would protrude outwardly from the battery case 18.

### Filling Electrolyte Solution and Sealing the Battery Case

An electrolyte solution was prepared by dissolving LiPF₆ at a concentration of 1 M (mol/L) in a mixed solvent of 30:70 volume ratio of ethylene carbonate (EC) and methyl ethyl carbonate (MEC). The electrolyte solution was filled into the battery case 18 from the remaining one side of the battery case that was not yet thermally bonded. Lastly, the one side that had not been thermally bonded was thermally bonded. Thus, a battery was prepared.

Advantageous Effects with the Battery According to the Embodiment

The stack type battery described in the above-described embodiment (hereinafter also referred to as the “prevent invention battery”) includes: a stacked electrode assembly 10 comprising a plurality (35 sheets) of positive electrode plates 1 having respective positive electrode current collector tabs 11 protruding therefrom, a plurality (36 sheets) of negative electrode plates 2 having respective negative electrode current collector tabs 12 protruding therefrom, and separators 3a interposed between the positive electrode plates 1 and the negative electrode plates 2, the positive electrode plates 1 and the negative electrode plates 2 being alternately stacked one another with the separators 3a; wherein: the stacked positive electrode current collector tabs 11 and the stacked negative electrode current collector tabs 12 are bundled respectively in such a manner as to be gathered at one stacking direction-wise side (the upper end side in FIG. 6) of the stacked electrode assembly 10, and portions of the bundled tabs extending from a bundled portion to a tip side of the bundled tabs are bent toward the other stacking direction-wise side (the lower end side in FIG. 6) of the stacked electrode assembly 10, to form bent portions; the stacked electrode assembly 10 is covered and fixed by an insulating sheet 5 having insulation capability so as to cover both stacking direction-wise end faces thereof and surround the stacked electrode assembly 10 in a tubular shape; and a slip-in piece 55, which is a portion of the insulating sheet 5, is inserted between the stacked electrode assembly 10 and the bent portions of the positive electrode current collector tabs 11 and the negative electrode current collector tabs 12, and an outer cover piece 51, which is a portion of the insulating sheet 5, covers the bent portions of the positive electrode current collector tabs 11 and the negative electrode current collector tabs 12 from outside.

With the above-described configuration of the present invention battery, the bent portions of the positive and negative electrode current collector tabs 11, 12 are retained in such a posture as to be sandwiched from inside and outside by the slip-in piece 55 and the outer cover piece 51, which are portions of the insulating sheet 5. Thereby, the current collector portion is retained and positioned at a predetermined position accurately and reliably, and the posture of the current collector portion is also retained, i.e., shaped, in a predetermined posture accurately and reliably. In addition, the positioning and shaping of the current collector portion are effected using the slip-in piece 55 and the outer cover piece 51, which are portions of the insulating sheet 5 that cover the stacked electrode assembly 10 so as to cover both stacking direction-wise end faces thereof (the exposed side faces of both of the outermost negative electrode plates 2) and surround the stacked electrode assembly 10 in a tubular shape. Therefore, the current collector portion is supported stably and firmly, and the positioning and shaping of the current collector portion can be carried out integrally with, i.e., at the same time as, the covering of the entire stacked electrode assembly 10 by the insulating sheet 5. As a result, the work can be done more easily and simply, and moreover accurately, in comparison with, for example, the case where the current collector portion is fixed locally by a tape.

Moreover, the stacked electrode assembly 10 is covered and fixed by the insulating sheet 5 so as to cover both stacking direction-wise end faces thereof and surround the stacked electrode assembly in a tubular shape. Therefore, the entire stacked electrode assembly can be fixed at one time unlike the case where a plurality of locations of the stacked electrode assembly are fixed by a tape. This makes the work easier and simpler, and the misalignment such as that occurs in the case of using a tape for fixing the parts does not occur easily. Therefore, the accuracy of the positioning can be ensured easily. Furthermore, unlike the case of using a tape for fixing the parts, it is possible to carry out the entire manufacturing process of the stacked electrode assembly 10 by a machine.

In addition, since the stacked electrode assembly 10 is covered by the insulating sheet 5 so as to cover both stacking direction-wise end faces thereof and surround the to stacked electrode assembly 10 in a tubular shape, the stacked electrode assembly 10 is provided with good insulation. In particular, the current collector portion is provided with good insulation since the current collector portion is retained in such a posture as to be sandwiched from inside and outside by the slip-in piece 55 and the outer cover piece 51, which are portions of the insulating sheet.

In addition, the portion of the insulating sheet 5, i.e., the slip-in piece 55, that is inserted between the stacked electrode assembly 10 and the bent portions of the positive electrode current collector tabs 11 and the negative electrode current collector tabs 12 is allowed to have a greater thickness than (two times the thickness as) the remaining portion of the insulating sheet 5, by the additional piece 55D affixed thereto. Therefore, the bent portions of the positive electrode current collector tabs 11 and the negative electrode current collector tabs 12 are supported from inside by the insulating sheet having a greater thickness, i.e., the slip-in piece 55. As a result, the positioning and shaping of the current collector portion can be done more easily and reliably.

In addition, the portion of the insulating sheet 5 covering the bent portions of the positive electrode current collector tabs 11 and the negative electrode current collector tabs 12 from outside, i.e., the outer cover piece 51, protrudes more than protruding ends of the bent portions of the positive electrode current collector tabs 11 and the negative electrode current collector tabs 12. Therefore, the metallic parts of the current collector portion, i.e., the bent portions of the positive and negative electrode current collector tabs 11, 12 and the positive and negative electrode current collector terminals 15, 16 (the folded pieces thereof) are covered by the insulating sheet 5 more reliably.

Moreover, a portion of the insulating sheet 5, i.e., the outer cover piece 51, protrudes about 1 mm more than the protruding ends of the bent portions of the positive electrode current collector tabs 11 and the negative electrode current collector tabs 12. Therefore, the difference between the protruding length of the outer cover piece 51 and the protruding length of the bent portions of the positive and negative electrode current collector tabs 11, 12 is not too small. As a result, the effect of reliably covering the metallic parts of the current collector portion, i.e., the bent portions of the positive and negative electrode current collector tabs 11, 12 and the positive and negative electrode current collector terminals 15, 16 (the folded pieces thereof), with the insulating sheet 5 is ensured. At the same time, the difference between the protruding length of the outer cover piece 51 and the protruding length of the bent portions of the positive and negative electrode current collector tabs 11, 12 is not too large. As a result, it is easy to avoid the problem that, for example, the protruding end portion of the outer cover piece 51 is tucked into the seal portion of the laminate battery case 18.

In addition, the front-side flaps 57 and the back-side flaps 58 are formed at the front-side edges and the back-side edges of the side wall pieces 56, each of which is a portion of a seam portion of the insulating sheet 5, and a portion of the scam portion is joined by overlaying and joining the front-side flaps 57 and the back-side flaps 58. As a result, the portion of the seam portion of the insulating sheet 5 can be joined easily and reliably.

Moreover, the stacked electrode assembly 10 is accommodated in the battery case 18 having flexibility, which is formed of the laminate films 17. It is also possible to use a battery can or the like as the battery case. However, in the case of the battery can, the battery can itself has certain shape-retaining capability (rigidity). Therefore, the positioning and shaping of the current collector portion are effected by configuring the current collector portion by fixing the positive and negative electrode current collector tabs to the battery can, and even when the battery receives external force, the position and posture of the current collector portion do not easily shift. In contrast, in the case of a battery case having flexibility such as the laminate battery case, the battery case itself does not have shape-retaining capability (rigidity). Therefore, it is necessary to conduct the positioning and shaping of the current collector portion by other parts than the battery case, and moreover, when the battery receives external force, for example, the position and posture of the current collector portion tend to shift easily. For these reasons, the configuration of the present invention battery, in which the positioning and shaping of the current collector portion are done by the slip-in piece 55 and the outer cover piece 51, which are portions of the insulating sheet 5, is especially effective in the case of the battery case having flexibility. In particular, the positioning of the electrode terminals and the current collection structure is important when thermally welding the laminate battery case under the condition in which the electrode assembly has been disposed in the laminate battery case and the current collector terminals have been sandwiched between the laminate films (in other words, when thermally welding and sealing the laminate battery case). In this respect, the configuration of the present invention battery, in which the positioning and shaping of the current collector portion are done by the slip-in piece 55 and the outer cover piece 51, which are portions of the insulating sheet 5, is particularly effective.

In addition, the laminate film has a structure in which both sides of a metal foil (aluminum foil) are coated with a resin, and therefore serves as an insulator. For this reason, when using the laminate battery case, the insulation between the stacked electrode assembly and the laminate battery case is generally unnecessary. Nevertheless, there may be cases in which the laminate battery case does not serve as a perfect insulator because the resin coating may peel off at, for example, a corner portion. Therefore, the configuration of the present invention battery, in which the stacked electrode assembly 10 is covered substantially entirely with the insulating sheet 5 having insulation capability, is particularly effective from the viewpoint of ensuring insulation.

The stack type battery is also configured to have the spacer 5S for filling a portion of the gap formed in the current collector portion, i.e., the gap formed between the slip-in piece 55 and the stacked electrode assembly 10 in an intermediate portion between the positive electrode current collector tabs 11 and the negative electrode current collector tabs 12. In the configuration in which the stacked electrode assembly is accommodated in a battery case having flexibility, creases and warpage occur in the battery case at the portion where a gap is formed if the gap is formed in the current collector portion when sealing the battery case while evacuating the inside of the battery case (i.e., when vacuum-sealing the battery case), because of the internal pressure change associated with the evacuation. In the configuration of the present invention battery, the gap formed between the slip-in piece 55 and the stacked electrode assembly 10 in an intermediate portion between the positive electrode current collector tabs 11 and the negative electrode current collector tabs 12 is filled by the spacer 5S. Therefore, the creases and warpage resulting from the evacuation can be prevented.

In addition, after covering and fixing the stacked electrode assembly 10 by the insulating sheet 5, the stacked electrode assembly 10 is fixed with pressure by heating the insulating sheet 5 to cause thermal shrinkage. As a result, the stacked electrode assembly 10 can be fixed more firmly and stably.

### Other Embodiments

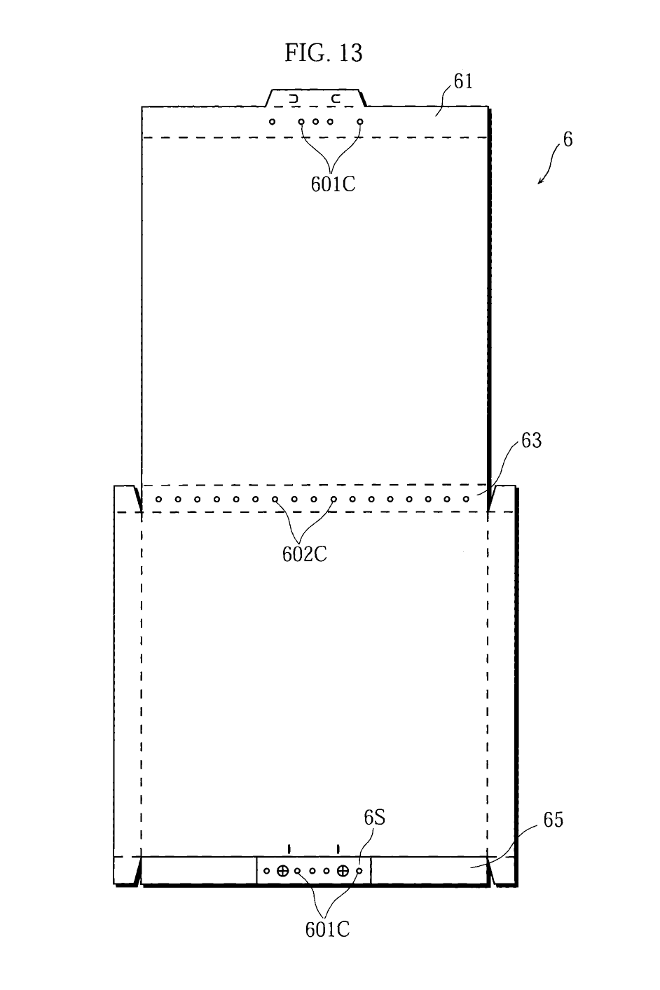

(1) In the present invention battery, the stacked electrode assembly 10 is covered and fixed by the insulating sheet 5 almost without forming any gap, so the stacked electrode assembly 10 is reliably fixed without causing shifts and reliably insulated at six faces. However, the seam portions are not bonded except for the portions bonded by the front-side flaps 57 and the back-side flaps 58, so the electrolyte solution can enter the interior. Here, as illustrated in FIG. 13 for example, an insulating sheet 6 may be provided with liquid passage ports 601C and 602C, which have opening areas such as not to degrade the position fixing function and the insulative capability, so that the entry of the electrolyte solution can be made more easily. The insulating sheet 6 shown in the figure has the same structure as the insulating sheet 5 the present invention battery described above, except that the liquid passage ports 601C and 602C are provided. The outer cover piece 61, the slip-in piece 65, and the spacer 6S have a row of a plurality (5) of circular liquid passage ports 601C spaced at a gap and formed at the corresponding locations so that the polls can communicate with each other after being assembled, and the back-wall portion 63 has a row of a plurality of (17) circular liquid passage ports 602C spaced at a gap. The liquid passage ports 601C and 602C allow the electrolyte solution to enter the interior more easily at the side on which the electrolyte solution is fed (the current collector side) and at the opposite side.

It is also possible that, for example, in the insulating sheet 5 of the present invention battery, at least one of the side wall pieces 56 may not be formed and the corresponding side face may be left open. With this configuration, the entry of the electrolyte solution can be made more easily while ensuring the function of bundling and fixing the stacked electrode assembly 10 by covering and fixing the stacked electrode assembly 10 so as to cover both stacking direction-wise end faces thereof and surround the stacked electrode assembly in a tubular shape with the outer cover piece 51, the upper wall portion 52, the back-wall portion 53, the lower wall portion 54, and the slip-in piece 55. However, from the viewpoints of ensuring insulation and preventing misalignment of the stacked electrode assembly 10 at the side faces (stabilizing the fixing state), it is desirable that the six faces be closed by forming both of the side wall pieces 56 also, as in the present invention battery.

(2) In the present invention battery, the spacer 5S is fixed to the slip-in piece 55 (specifically to the additional piece 55D thereof) by ultrasonic welding. However, it is also possible to fix the spacer 5S by other methods, such as thermal welding, an adhesive agent, and an adhesive tape, either alone or in combinations with ultrasonic welding. Likewise, in the present invention battery, the additional piece 55D is affixed to the slip-in piece 55 by an adhesive agent. However, it is also possible to affix the additional piece 55D by other methods, such as ultrasonic welding and thermal welding, either alone or in combinations with the adhesive agent. Moreover, in the present invention battery, the front-side flaps 57 and the back-side flaps 58 are joined respectively to the outer cover piece 51 and the back-wall portion 53 by thermal welding. However, the front-side flaps 57 and the back-side flaps 58 may be joined by other methods, such as an adhesive agent and an adhesive tape, either alone or in combination with the thermal welding. Furthermore, in the present invention battery, the securing piece 59 is fixed by inserting the grommet portions 59F into the slits 54F of the lower wall portion 54. However, it is also possible to fix the securing piece 59 by other methods, such as thermal welding, an adhesive agent, and an adhesive tape, either alone or in combinations with the grommet portions.

(3) The positive electrode active material is not limited to lithium cobalt oxide. Other usable materials include lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as spinel-type lithium manganese oxides.

(4) Other than the graphite such as natural graphite and artificial graphite, various materials may be employed as the negative electrode active material as long as the material is capable of intercalating and deintercalating lithium ions. Examples include coke, tin oxides, metallic lithium, silicon, and mixtures thereof.

(5) The electrolyte is not limited to that shown in the examples above, and various other substances may be used. Examples of the lithium salt include LiBF₄, LiPF₆, LiN(SO₂CF₃)₂, LiN(SO₂C₂F₅)₂, and LiPF₆₋ₓ(CₙF₂ₙ₊₁)ₓ (wherein 1<x<6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte solution. The types of the solvents are not particularly limited to EC and MEC mentioned above. Examples of preferable solvents include carbonate solvents such as propylene carbonate (PC), γ-butyrolactone (GBL), ethyl methyl carbonate (EMC), dimethyl carbonate (DMC), and diethyl carbonate (DEC). More preferable is a combination of a cyclic carbonate and a chain carbonate.

(6) Examples of the material usable for the insulating sheet include polyethylene, polypropylene, modified polyolefin, polyvinyl chloride, and polystyrene. It is preferable that the thickness of the insulating sheet be from about 10 μm to about 500 μm. When the insulating sheet needs to be thermally shrunk, it is preferable to use an insulating sheet made of a material that undergoes thermal shrinkage by conducting a heat treatment at 100° C. to 200° C. for several seconds to several minutes.

The present invention is suitably applied to, for example, power sources for high-power applications, such as backup power sources and power sources for the motive power incorporated in robots and electric automobiles.

While detailed embodiments have been used to illustrate the present invention, to those skilled in the art, however; it will be apparent from the foregoing disclosure that various changes and modifications can be made therein without departing from the spirit and scope of the invention. Furthermore, the foregoing description of the embodiments to according to the present invention is provided for illustration only, and is not intended to limit the invention.

What is claimed is:

1. A stack type battery comprising:
a stacked electrode assembly comprising a plurality of positive electrode plates having respective positive electrode current collector tabs protruding therefrom, a plurality of negative electrode plates having respective negative electrode current collector tabs protruding therefrom, and separators interposed between the positive electrode plates and the negative electrode plates, the positive electrode plates and the negative electrode plates being alternately stacked one another with the separators; wherein:
the stacked positive and negative electrode current collector tabs are bundled in such a manner as to be gathered at one stacking direction-wise side of the stacked electrode assembly, and portions of the bundled tabs extending from a bundled portion to a tip side of the bundled tabs are bent toward the other stacking direction-wise side of the stacked electrode assembly, to form bent portions;
the stacked electrode assembly is covered and fixed by an insulating sheet having insulation capability so as to cover both stacking direction-wise end faces thereof and surround the stacked electrode assembly in a tubular shape; and
a portion of the insulating sheet is inserted between the stacked electrode assembly and the bent portions of the positive and negative electrode current collector tabs, and a portion of the insulating sheet covers the bent portions of the positive and negative electrode current collector tabs from outside.

2. The stack type battery according to claim 1, wherein the portion of the insulating sheet inserted between the stacked electrode assembly and the bent portions of the positive and negative electrode current collector tabs has a greater thickness than the remaining portion of the insulating sheet.

3. The stack type battery according to claim 1, wherein the portion of the insulating sheet covering the bent portions of the positive and negative electrode current collector tabs from outside protrudes more than protruding ends of the bent portions of the positive and negative electrode current collector tabs.

4. The stack type battery according to claim 2, wherein the portion of the insulating sheet covering the bent portions of the positive and negative electrode current collector tabs from outside protrudes more than protruding ends of the bent portions of the positive and negative electrode current collector tabs.

5. The stack type battery according to claim 3, wherein the portion of the insulating sheet protrudes 0.5 mm to 1.0 mm more than the protruding ends of the bent portions of the positive and negative electrode current collector tabs.

6. The stack type battery according to claim 4, wherein the portion of the insulating sheet protrudes 0.5 mm to 1.0 mm more than the protruding ends of the bent portions or the positive and negative electrode current collector tabs.

7. The stack type battery according to claim 1, wherein the insulating sheet has a flap formed at least a portion of a seam portion of the insulating sheet, the flap being configured to join at least a portion of the seam portion by overlaying and joining the flap thereto.

8. The stack type battery according to claim 2, wherein the insulating sheet has a flap formed at least a portion of a seam portion of the insulating sheet, the flap being configured to join at least a portion of the seam portion by overlaying and joining the flap thereto.

9. The stack type battery according to claim 1, wherein the stacked electrode assembly is accommodated in a battery ease having flexibility.

10. The stack type battery according to claim 2, wherein the stacked electrode assembly is accommodated in a battery case having flexibility.

11. The stack type battery according to claim 3, wherein the stacked electrode assembly is accommodated in a battery case having flexibility.

12. The stack type battery according to claim 4, wherein the stacked electrode assembly is accommodated in a battery case having flexibility.

13. The stack type battery according to claim 9, further comprising a spacer for filling at least a portion of a gap formed in a current collector portion.

14. The stack type battery according to claim 10, further comprising a spacer for filling at least a portion of a gap formed in a current collector portion.

15. The stack type battery according to claim 11, further comprising a spacer for filling at least a portion of a gap formed in a current collector portion.

16. The stack type battery according to claim 12, further comprising a spacer for filling at least a portion of a gap formed in a current collector portion.

17. The stack type battery according to claim 1, wherein the insulating sheet has a liquid passage port.

18. The stack type battery according to claim 2, wherein the insulating sheet has a liquid passage port.

19. The stack type battery according to claim 1, wherein the stacked electrode assembly is fixed with pressure applied by the insulating sheet covering and fixing the stacked electrode assembly, the insulating sheet being a heat shrunk sheet.

20. The stack type battery according to claim 2, wherein the stacked electrode assembly is fixed with pressure applied by the insulating sheet covering and fixing the stacked electrode assembly, the insulating sheet being a heat shrunk sheet.
